(19) United States
(12) Patent Application Publication
(10) Pub. No.: US 2017/0245439 A1
(43) Pub. Date: Aug. 31, 2017

(54) ROLLER BEARING PRUNER

(71) Applicant: Barnel International, Inc., Portland, OR (US)

(72) Inventors: Linn E. Nelson, Portland, OR (US); Karl H. Zeller, Portland, OR (US)

(73) Assignee: Barnel International, Inc., Portland, OR (US)

(21) Appl. No.: 15/441,012

(22) Filed: Feb. 23, 2017

Related U.S. Application Data
(60) Provisional application No. 62/299,865, filed on Feb. 25, 2016.

(30) Foreign Application Priority Data
Oct. 24, 2016 (CN) 201621152821.8
Oct. 24, 2016 (TW) 105216160

(51) Int. Cl. A01G 3/025

(52) U.S. Cl. CPC A01G 3/025

(57) ABSTRACT

A pruner comprises a pair of handles held in cooperative movement relation by a pivot lubrication bolt. A bearing such as a needle roller bearing is employed to provide superior operation.

This application claims benefit of U.S. Provisional Patent Application Ser. No. 62/299865, filed Feb. 25, 2016, entitled ROLLER BEARING PRUNER.

### BACKGROUND OF THE INVENTION

This invention relates to pruning tools, and more particularly to a pruner that is adapted for smooth ease of use in the field.

Pruners have many uses in gardening and agricultural products production, such as pruning bushes and trees, harvesting fruits, etc.

The repeated motion of opening and closing the pruner can over time lead to fatiguing of the user's hand.

### SUMMARY OF THE INVENTION

In accordance with the invention, an improved pruner is provided that provides smoother operation than prior art pruners.

The subject matter of the present disclosure is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a front view of a pruner in accordance with the present disclosure;

FIG. 2 is an exploded view of the pruner;

FIG. 3 is a view of central portion of the back side of one handle portion;

FIG. 4 is a partial view of handle portion 14 illustrating the placement of the needle roller bearing member

FIG. 5 is a partially cut away view of an example needle roller bearing;

FIG. 6 is a cross cut away view of the needle roller bearing of FIG. 5; and

FIG. 7 is a cut away view of an alternative roller bearing;

### DETAILED DESCRIPTION

According to a preferred embodiment of the present invention, a pruner adapted for smooth use is provided, suitably a hand held pruner.

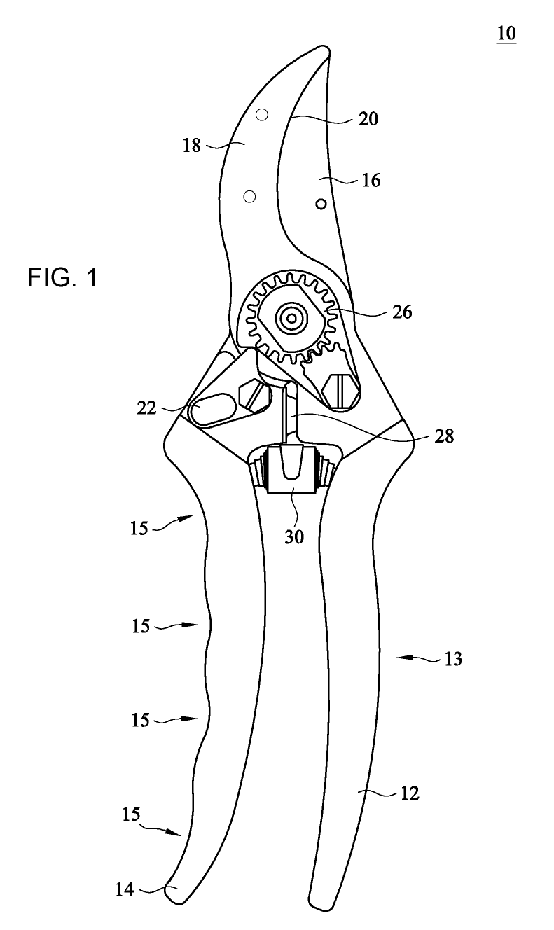

Referring to FIG. 1, a front view of the pruner, the pruner 10 employs first and second handles 12, 14, suitably constructed of metal covered with a plastic coating material, suitably applied by dipping the handles in vinyl during manufacturing. Handle 12 has a slightly curved outer portion 13 to fit comfortably in a user's palm while the outer portion of handle 14 has curved indentations 15 (4 in the illustrated embodiment) to fit the user's fingers comfortably therein. The shape of the two handle portions provides an ergonomic fit with a user's hand. The handles and other body parts of the pruner are suitably made of drop forged aluminum in the preferred embodiment, providing strength and light weight to the pruner.

Attached to the operational end of handle 14 is a cutting blade, preferably made of high carbon sword steel. The operational end of handle 12 defines a curved jaw portion 18 that includes a sap groove 20 to allow sap that might appear from cut branches to move away from the blade to reduce fouling between the blade and opposing jaw of the pruner.

A 2 position lock 22 is provided to allow the pruner to be locked in a closed position, and further to adjust the maximum amount that the pruner will open in use, so that the pruner can be set to open less for use in cutting smaller items, reducing long term fatigue on the user's hand, or can be set to open much wider for cutting operations on larger items.

The two portions of the pruner are held together by an oiler bolt 24 (discussed below) and a nut portion 26. A shock absorbing bumper 28 provides cushioning as the pruner handles are closed together, to reduce fatigue during long periods of use. A spring 30 is positioned between the two handle portions to urge the pruner towards an open configuration in absence of closing force by the user, so that upon release of operational pressure by the user's hand, the pruner will open to release from a cutting operation.

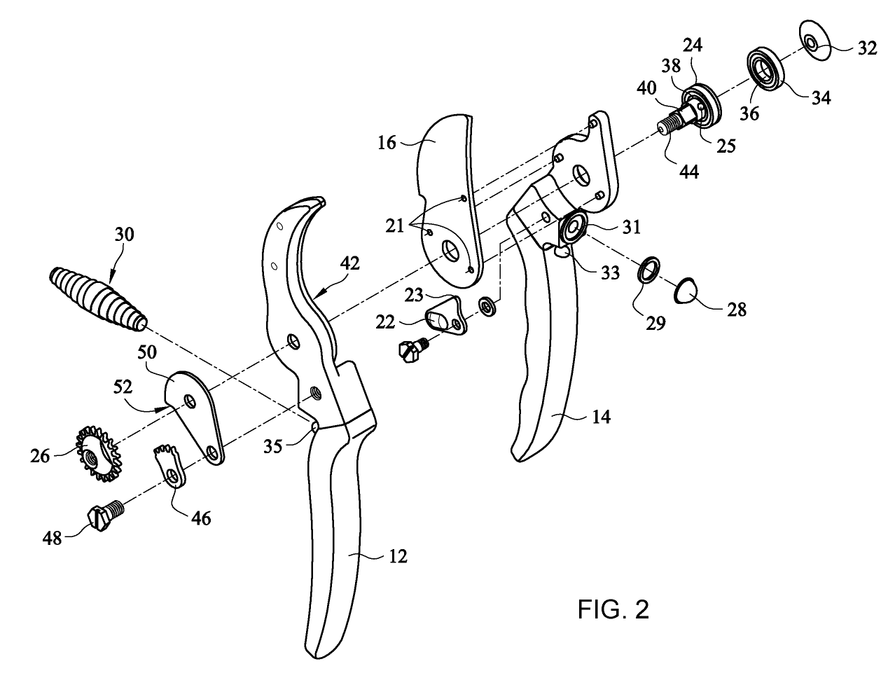

Referring to FIG. 2, an exploded view of an exemplary pruner, an oiler bolt 24, also known as a pivot lubrication bolt such as described in U.S. patent application Ser. No. 10/954,795, published application US2006-0067787-A1 (the disclosure of which is incorporated herein by reference), by the present inventors, is provided to, in conjunction with nut 26, hold the portions of the pruner together in use while allowing movement of the handle portions at the same time as providing lubrication of the moving joint. Lubrication can be added to the oiler bolt by injection of oil or other lubricant in the center of the oiler bolt through a spring loaded cap member that can be pushed out of the way to receive additional lubrication, and then reseal the lubrication receiving opening to avoid loss of lubricant. The oiler bolt includes a central passage 25 which releases oil or other lubrication held within the interior of the bolt into the center of the pruner bearing for lubrication thereof.

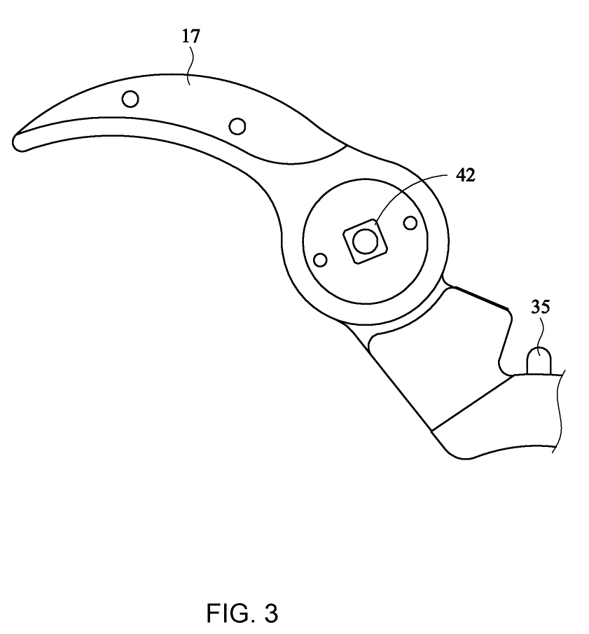

An improvement over prior art pruners is provided with the current device by the addition of needle roller bearing member 34 which in the illustrated configuration has a circular center opening 36, which, when the device is assembled, seats on corresponding circular shoulder 38 on the oiler bolt. The oiler bolt includes a rectangular cross section portion 40 (suitably square cross section) that mates with a correspondingly shaped cross section opening 42 in one of the handle portions, suitably handle portion 12 in the preferred embodiment, visible in FIG. 3, a view of central portion of the back side of handle portion 12.

Threaded portion 44 of the oiler bolt engages the corresponding threaded portion of nut 26 to allow the pruner to be assembled and tightened for operation.

Lock member 46 has teeth that mate with corresponding teeth positioned on nut 26, such that once the pruner oiler bolt/nut combination is tightened to a desired degree, the lock member 46 is rotated such that its teeth engage the teeth of nut 26, and the lock member is tightened to position (secured to the handle body by bold 48.

The user can alternately lock or unlock the pruner by movement of the pivoting lock 22 such that the distal end 23 engages seat 52 of lock plate 50 to lock the pruner to a closed position, or, by movement of the pivoting lock so that it does not interact with seat 52, allowing the pruner to open.

Spring 30, suitably a barrel spring in the particular illustrated embodiment, is provided to assist the blade to an open position when the user's hand opens. Other spring types or biasing mechanisms may also be employed.

The blade portion 16 interacts with a corresponding blade portion 17 on the opposite handle, to provide cutting operations by opening and closing the user's hand to open and close the blades to effect a cutting operation. The blade may be mounted to the handle portion 14 by use of mounting pins 19 positioned on the handle portion and received in corresponding mounting holes 21 in the blade. Corresponding mounting pins/holes may be provided for removably mounting blade portion 17 also, thereby allowing replacement of the blades if desired.

The blade is suitably curved as illustrated to provide ease of access to fruit stems to be cut in harvesting, even in tight spacing conditions.

Shock absorber 28 is held in place at a shock absorber seat by use of a retaining ring 29. Spring 30 is held in position by mounting pins 33, 35 on opposing handle portions, which fit into the ends of the spring.

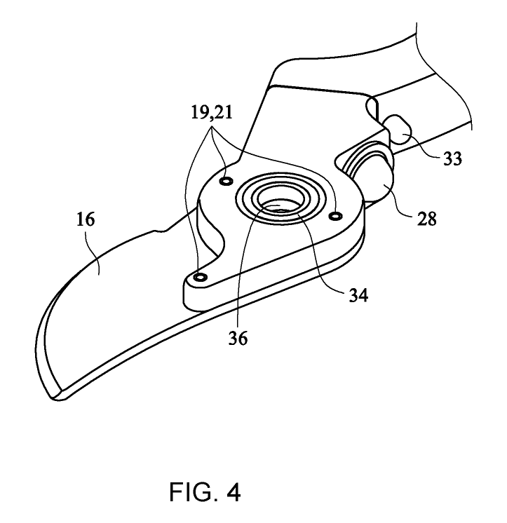

FIG. 4 is a partial view of handle portion 14 illustrating the placement of the needle roller bearing member 34 therein.

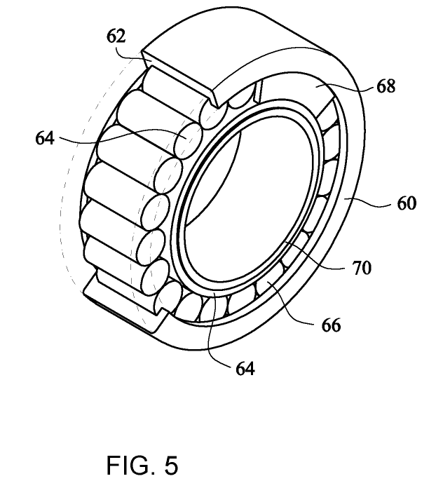

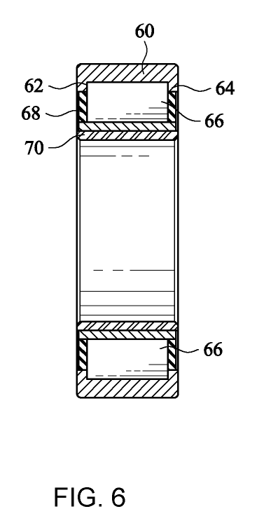

Referring to FIG. 5, a partially cut away view of an example needle roller bearing and FIG. 6 a cross cut away view of the needle roller bearing of FIG. 5 taken along line 6-6, the bearing comprises an outer ring 60 with shoulders 62, 64 that define a roller receiving channel that carries needle rollers 66 therein. The needle rollers typically comprises cylindrical roller with a large length to diameter ratio. Not shown in FIG. 5 is a shield 68 which covers the cavity having the needle rollers to prevent entry of contaminants or dirt.

In use, the needle rollers smoothly roll between the inner surface of outer ring 60 and inner ring 70, allowing inner ring 70 to smoothly rotate as the pruner handles are moved.

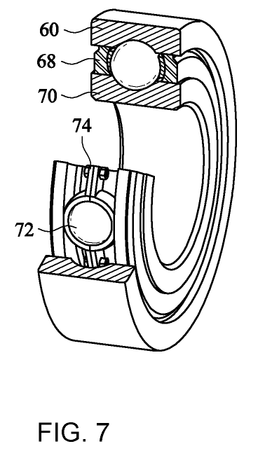

FIG. 7 is a cut away view of an alternative roller bearing using balls 72 held in position by cages 74, in place of needle rollers 66.

Accordingly, a pruner is provided where a lubrication center bolt engages a rotating bearing, suitably a needle bearing in a preferred embodiment, for very smooth operation of the pruner, which thereby promotes faster easier cuts, reduces fatigue, operates with less friction, providing improved ergonomics.

The pruner therefore provides an ergonomic configuration adapted for long use in field, reducing user's tiring.

Typically the blades are made of high carbon steel, precision ground and heat treated for lasting blade sharpness. Other blade materials can be employed, if lasting blade sharpness is a less important issue in the particular planned use of the shear, where, for example, the ability of the blade to hold an edge over time is less desired than is greater resistance to breaking in rough usage conditions, for example, whereby a lower carbon content steel may be employed.

Thus, in accordance with the disclosure, an improved hand held pruner is provided that employs a roller bearing, and an oiler bolt for lubrication during operation, resulting in a better pruner that operates more smoothly, faster and easier than prior pruners.

While a preferred embodiment of the present technology has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A pruner, comprising:
a blade portion;
cooperating handle portions; and
a bearing for allowing relative movement of the handle members to one another about an axis.

2. The pruner according to claim 1, wherein said bearing comprises a needle roller bearing.

3. The pruner according to claim 2, wherein said handle portions are held together by use of a pivot lubrication bolt.

4. The pruner according to claim 1, wherein said bearing comprises a roller bearing.

5. The pruner according to claim 4, wherein said handle portions are held together by use of a pivot lubrication bolt.

6. A hand held pruner, comprising:
a blade portion;
cooperating handle portions held in movable relation to one another by a pivot lubrication bolt; and
a bearing for allowing relative movement of the handle members to one another about an axis.

7. The hand held pruner pruner according to claim 6, wherein said bearing comprises a needle roller bearing.

8. The hand held pruner according to claim 6, wherein said bearing comprises a roller bearing.

9. A method of providing a hand held pruner, comprising:
providing a blade portion;
providing cooperating handle portions held in movable relation to one another by a pivot lubrication bolt; and
providing a bearing for allowing relative movement of the handle members to one another about an axis.

10. The method according to claim 9, wherein said bearing comprises a needle roller bearing.

11. The method according to claim 9, wherein said bearing comprises a roller bearing.
